(19) United States
(12) Patent Application Publication
(10) Pub. No.: US 2012/0262367 A1
(43) Pub. Date: Oct. 18, 2012

(54) FLEXIBLE ELECTRONIC DEVICE

(75) Inventors: Teng-Yi CHIU, Taipei Hsien (TW); Wen-Chin WU, Taipei Hsien (TW)

(73) Assignee: Wistron Corporation, Taipei Hsien (TW)

(21) Appl. No.: 13/444,056

(22) Filed: Apr. 11, 2012

(30) Foreign Application Priority Data
Apr. 13, 2011 (TW) 100112846

(51) Int. Cl. G06F 3/01

(52) U.S. Cl. 345/156

(57) ABSTRACT

A flexible electronic device can be operated in multiple operation modes. The flexible electronic device mainly includes a substrate, a flexible display module, at least one folding device, a button module, and a processing unit. The flexible display module is located above the substrate, and the at least one folding device is used for folding the display. When the display is unfolded, a main display is launched on the display. When the display is folded, the main display can be divided into a plurality of sub-display zones such that images or graphics can be displayed on one of the sub-display zones. The button module is located on one of the sub-display zones. The processing unit is electronically connected to the button module in order to operate the flexible electronic device.

### BACKGROUND OF THE DISCLOSURE

1. Field of the Disclosure

The present disclosure relates to a flexible electronic device, especially a flexible electronic device that can be operated in a plurality of operating modes.

2. Description of the Related Art

The mobile phone is an electronic device carried by almost everyone in modern society. Because the TFT display screen mounted on a mobile phone is usually small and has a limited size, mobile phones are not widely considered proper devices for reading. In contrast, e-paper is commonly used as the display module of an e-reader. This kind of display module uses an environmental light source as a lighting resource to display images without the use of a backlight source, resulting in electricity consumption lower than that of TFT display modules. With this unique feature, e-paper displays can operate normally even outdoors. The main drawback of e-readers, however, is that they usually have no communicating functions. As a result, users have to carry a mobile phone for communicating and an e-reader for reading while commuting, causing inconvenience to users.

A keypad or button module is needed for operating the multiple functions of the soft display modules of electronic devices, and the technology is described in U.S. Pat. No. 6,067,074. However, that patent describes only soft display modules in conjunction with physical keys for operating multiple functions. Furthermore, the described technology does not include audio operations, and the soft display module cannot be operated in various usage modes while it is in the opened or folded states.

Therefore, it is necessary to provide an electronic device that not only combines the features of mobile phones and e-readers but also integrates a soft display, an operating keyboard, and an audio device together. Using the flexibility of the e-paper display to change the size of the display for switching among the usage modes of the electronic device is a breakthrough in the development of mobile phones and e-readers.

### SUMMARY OF THE INVENTION

An object of the present disclosure is to provide a flexible electronic device that can operate in various operating modes while it is in the opened state or in the folded state.

Another object of the present disclosure is to provide a flexible display module having a main display area while it is in the opened state that can be divided into a plurality of sub-display zones, each of which can display different information.

Another object of the present disclosure is to provide a flexible electronic device that can be operated as an e-reader while it is in the opened state and can be operated as an audio communication device while it is in the folded state.

Another object of the present disclosure is to provide a flexible electronic device whose display module can be folded outwards such that the display module still remains on the exposed surface of the flexible electronic device after folding; i.e., both the front side and the rear side of the flexible electronic device are covered by the display module.

To achieve the aforementioned objects, the flexible electronic device of the present disclosure comprises a flexible display module, a substrate, at least one folding device, a button module, and a processing unit. The flexible display module is mounted on the substrate. At least one folding device is used for folding the flexible display module. The flexible display module has a main display area for displaying graphics while the flexible display module is in the opened state. While the flexible display module is in the folded state, the main display area can be divided into a plurality of sub-display zones, at least one of which is adapted for displaying graphics. The button module is mounted on one of the plurality of sub-display zones. The processing unit is electronically connected to the button module for implementing operations of the flexible electronic device.

In one embodiment of the present disclosure, the flexible electronic device further comprises an audio device for allowing the flexible electronic device to operate in an e-reader mode or an audio communication mode.

In another embodiment of the present disclosure, the main display area is divided into two sub-display zones after the flexible electronic device is folded, and a transparent cover is mounted on the flexible electronic device.

### BRIEF DESCRIPTION OF THE DRAWINGS

FIG. 1 illustrates the hardware structure of the first embodiment of the flexible electronic device.

FIG. 2 is a schematic drawing illustrating an opened state of the present disclosure according to the first embodiment of the flexible electronic device.

FIG. 3 is a schematic drawing showing the movement of folding the flexible electronic device according to the first embodiment of the flexible electronic device.

FIG. 4a is a schematic drawing illustrating a front side of the flexible electronic device while the flexible electronic device is in a folded state according to the first embodiment of the flexible electronic device.

FIG. 4b is a schematic drawing illustrating a rear side of the flexible electronic device while the flexible electronic device is in a folded state according to the first embodiment of the flexible electronic device.

FIG. 5 illustrates the hardware structure of the second embodiment of the flexible electronic device.

FIG. 6 is a schematic drawing illustrating an opened state of the present disclosure according to the second embodiment of the flexible electronic device.

FIG. 7 is a schematic drawing illustrating a site of a button module of the flexible electronic device according to the second embodiment of the flexible electronic device.

FIG. 8 is a schematic drawing illustrating sites of a sensing device and a processing unit of the flexible electronic device according to the second embodiment of the flexible electronic device.

FIG. 9a is a schematic drawing illustrating a front side of the flexible electronic device while the flexible electronic device is in a folded state according to the second embodiment of the flexible electronic device.

FIG. 9b is a schematic drawing illustrating a rear side of the flexible electronic device while the flexible electronic device is in a folded state according to the second embodiment of the flexible electronic device.

FIG. 10 is a schematic drawing showing the movement of folding the flexible electronic device according to the third embodiment of the flexible electronic device.

### DETAILED DESCRIPTION OF THE PREFERRED EMBODIMENT

The advantages and innovative features of the disclosure will become more apparent from the following detailed descriptions when taken together with the accompanying drawings.

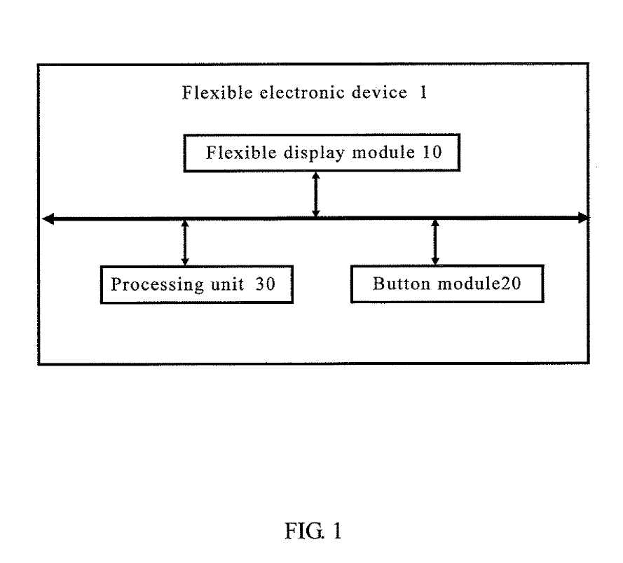

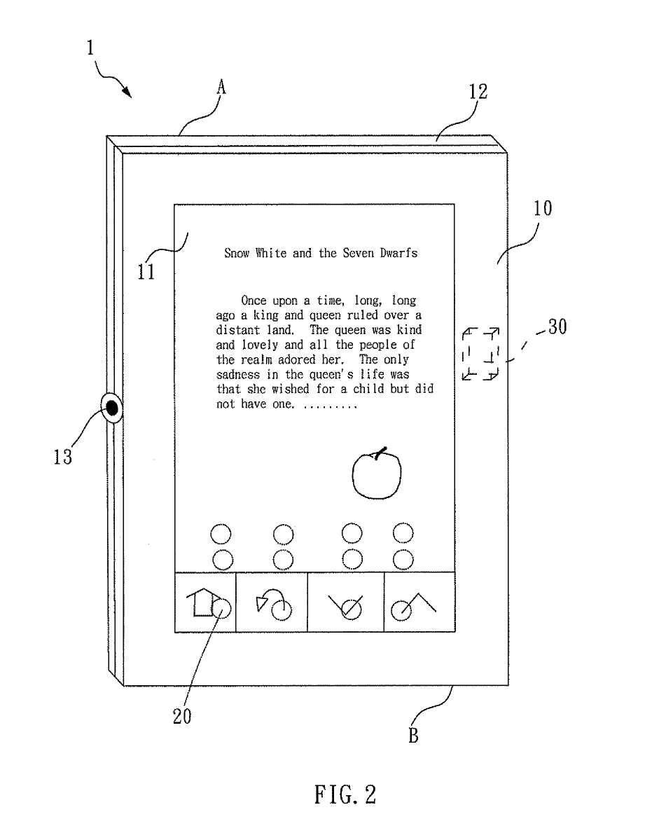

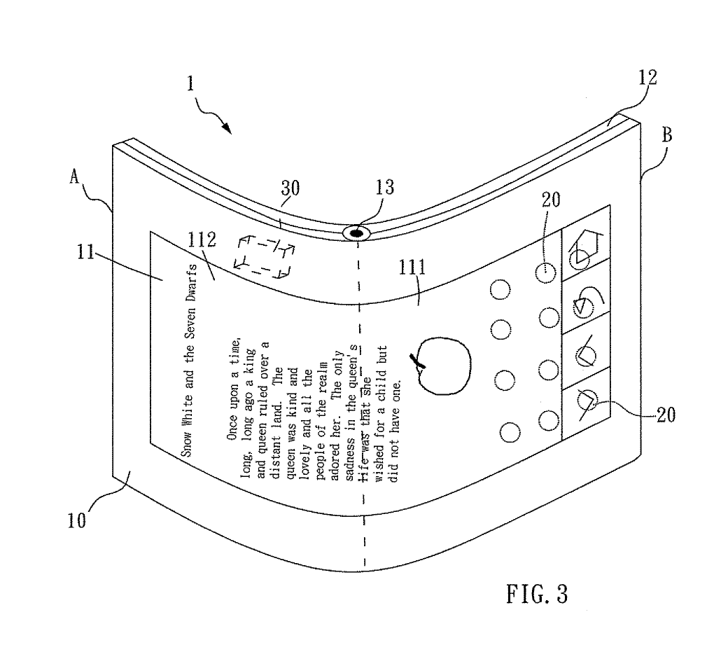

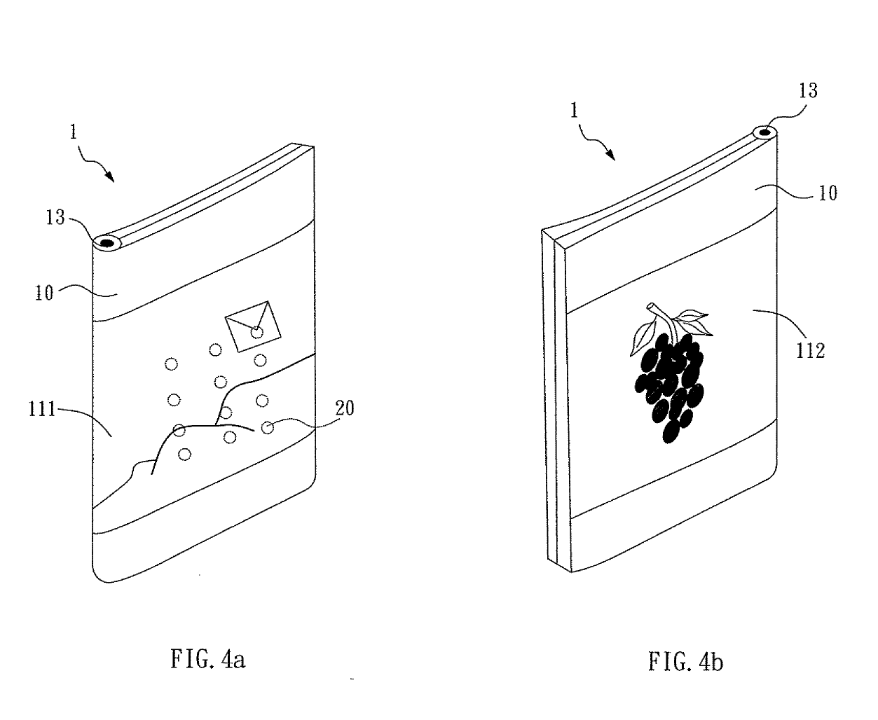

Please refer to FIG. 1 to FIG. 4b regarding the first embodiment of the flexible electronic device, wherein FIG. 1 illustrates the hardware structure of the first embodiment of the flexible electronic device; FIG. 2 is a schematic drawing illustrating an opened state of the present disclosure; FIG. 3 is a schematic drawing showing the movement of folding the flexible electronic device; FIG. 4a is a schematic drawing illustrating a front side of the flexible electronic device while the flexible electronic device is in a folded state; and FIG. 4b is a schematic drawing illustrating a rear side of the flexible electronic device while the flexible electronic device is in a folded state.

As shown in FIG. 1 and FIG. 2, the hardware structure of the first embodiment of the flexible electronic device mainly comprises: a flexible display module 10, a button module 20, and a processing unit 30. The flexible electronic device 1 of the present disclosure further comprises a substrate 12 and at least one folding device 13, wherein the flexible display module 10 is mounted on the substrate 12. The folding device 13 is used for folding the flexible display module 10 and leading the substrate 12 to fold correspondingly. Therefore, the flexible electronic device 1 can be opened or folded such that a plurality of operating modes can be operated accordingly. As shown in FIG. 2, information such as characters or graphics can be displayed on a main display area 11 of the flexible display module 10. In this embodiment, the flexible display module 10 is an e-paper display, and the button module 20 is mounted beneath the main display area 11. The processing unit 30 for implementing operation of the flexible electronic device 1 is electrically connected to the button module 20. The processing unit 30 can be a software program or an electrical circuit device with software programs which is capable of implementing various operations according to operating systems or application software installed in the flexible electronic device 1. It is noted that the present disclosure is not limited to the abovementioned embodiments.

As shown in FIG. 3, while the flexible display module 10 is being folded by rotating the hinge of the folding device 13, an A side of the flexible display module 10 and a B side of the flexible display module 10 can move closer to each other until the A side of the flexible display module 10 contacts the B side of the flexible display module 10 such that a folded state, illustrated in FIG. 4a and FIG. 4b, is formed. While the electronic device 1 is in the folded state, the folding device 13 can be used as a dividing line for dividing the main display 11 of the flexible display module 10 into a plurality of sub-display zones. It is noted that although the main display 10 in FIG. 3 is divided into two sub-display zones, namely sub-display zone 111 and sub-display zone 112, the present disclosure is not limited to this embodiment. In fact, the flexible display module 10 can be divided into multiple sections, the number of which depends on the quantity and location of the folding devices 13. Therefore, the number of the plurality of sub-display zones may vary. It should be noted that FIG. 3 is used for illustration only. After the flexible electronic device 1 is in the folded state, a front side of the flexible electronic device 1 (as shown in FIG. 4a) and a rear side of the flexible electronic device 1 (as shown in FIG. 4b) both have display screens. In this embodiment, the button module 20 is mounted on the front side of the flexible electronic device 1, and the button module 20 allows users to manipulate the flexible electronic device 1 for uses such as sending emails or displaying graphs (as shown in FIG. 4a). The rear side of the flexible electronic device 1 is used for displaying graphics, but the operating modes of the present disclosure are not limited to the above-mentioned embodiments.

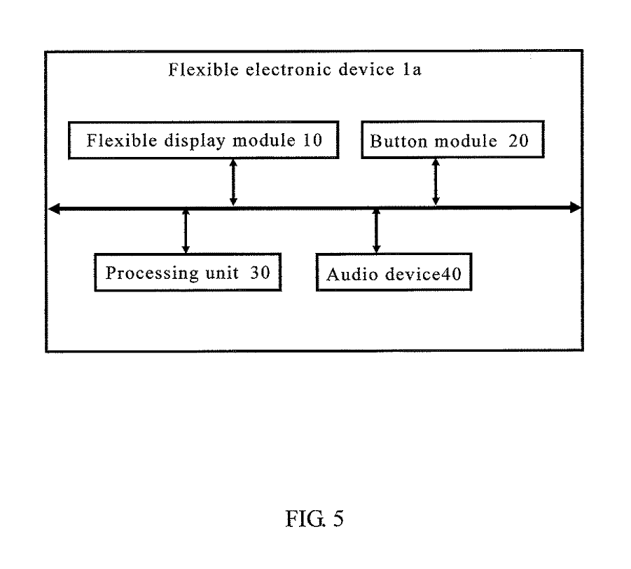

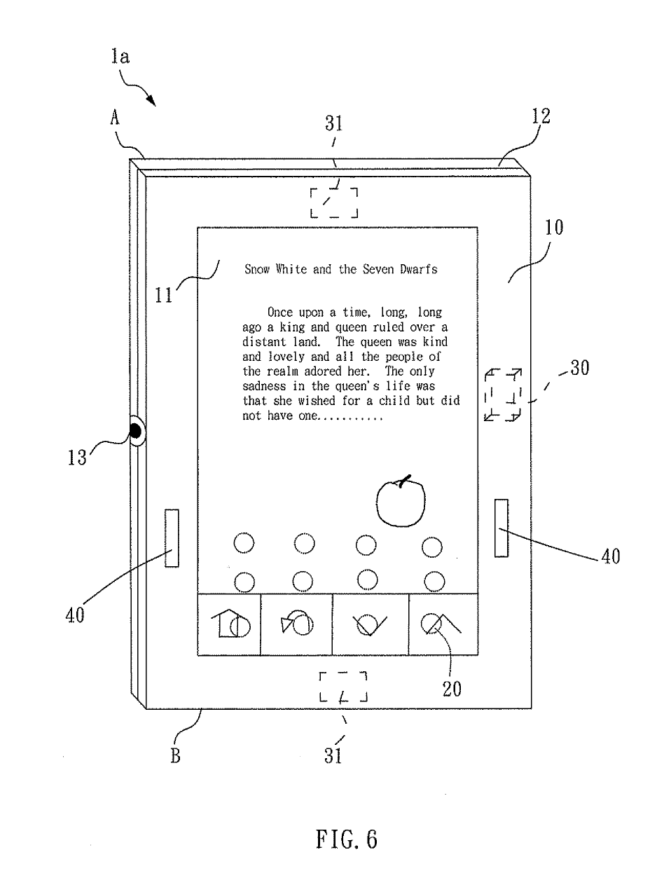

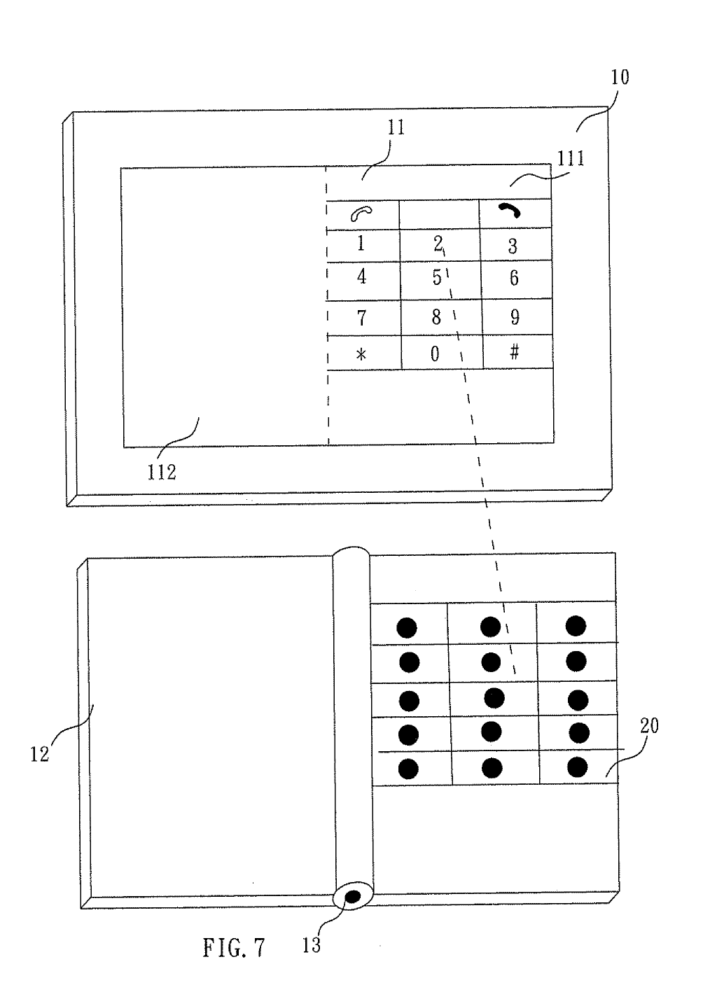

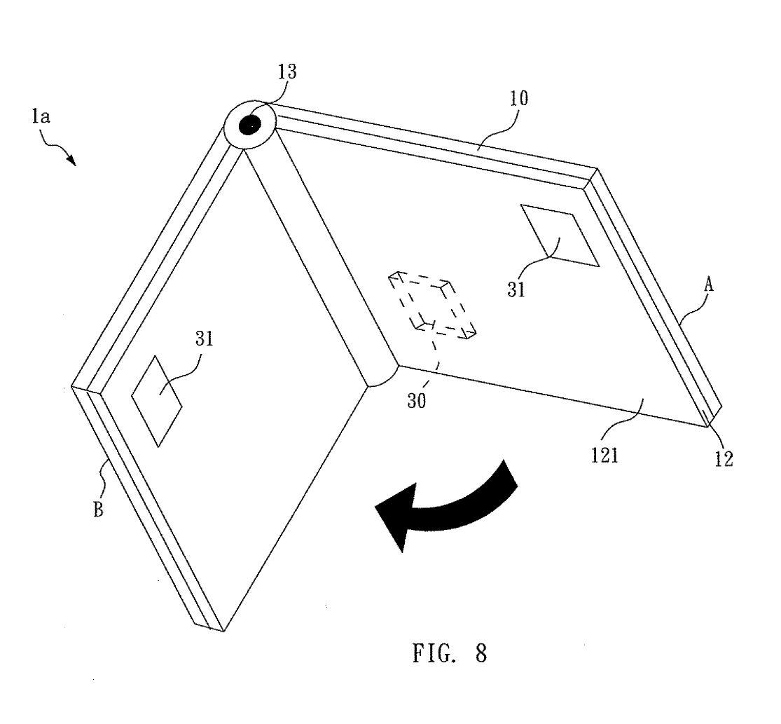

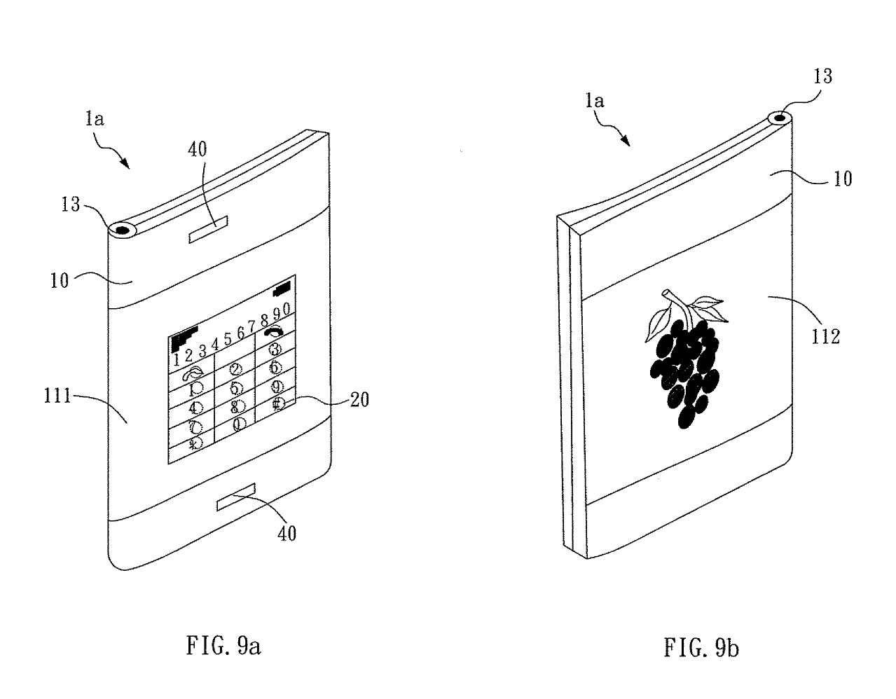

Please refer to FIG. 5 to FIG. 9b regarding the second embodiment of the flexible electronic device, wherein FIG. 5 illustrates the hardware structure of the second embodiment of the flexible electronic device; FIG. 6 is a schematic drawing illustrating an opened state of the present disclosure; FIG. 7 is a schematic drawing illustrating a site of a button module of the flexible electronic device; FIG. 8 is a schematic drawing illustrating the sites of a sensing device and a processing unit of the flexible electronic device; FIG. 9a is a schematic drawing illustrating a front side of the flexible electronic device while the flexible electronic device is in a folded state; and FIG. 9b is a schematic drawing illustrating a rear side of the flexible electronic device while the flexible electronic device is in a folded state.

In the second embodiment of the present disclosure, the present disclosure provides a flexible electronic device 1a that can be operated in an e-reader mode or an audio communication mode. In order to operate in the audio communication mode, the flexible electronic device 1a has an audio device 40, which is the most distinguishable difference between the flexible electronic device 1 and the flexible electronic device 1a. As shown in FIG. 5, the audio device 40 is electrically connected to the processing unit 30 for facilitating making phone calls or playing music. As shown in FIG. 6, when the flexible display module 10 is in the opened state, the flexible electronic device 1a is operated in an e-reader mode and the processing unit 30 implements corresponding operations of the e-reader mode. When the flexible display module 10 is in the folded state, the flexible electronic device 1a is operated in an audio communication mode and the processing unit 30 implements corresponding operations of the audio communication mode. While the flexible electronic device 1a is operating in the audio communication mode, users can receive or send sounds or voice through the audio device 40. In this embodiment, the audio device 40 comprises a sound emission device such as an audio speaker and a sound reception device such as a microphone. It is noted that although the audio device 40 is mainly used in the audio communication mode, the present disclosure is not restricted to that. The audio device 40 can also be used in the e-reader mode to enhance the applicability of the present disclosure.

As shown in FIG. 7, the substrate 12 is located beneath the flexible display module 10, and the folding device 13 is mounted on the substrate 12. In this embodiment, the folding device 13 is located in the middle of the substrate 12 in terms of length; therefore, while the flexible electronic device 1a is in the folded state, the main display area 11 of the flexible display module 10 is divided into two sub-display zones: sub-display zone 111 and sub-display zone 112. The sub-display zone 111 is used for displaying information such as figures or graphics. The button module 20 is situated on the substrate 12 and under the sub-display zone 111 for implementing operation of audio communication devices such as a mobile phone. In this embodiment, the button module 20 is a plurality of physical keys. It is noted that the button module 20 of the present disclosure is not limited to the above-mentioned embodiment; i.e., the button module 20 can also be a plurality of virtual keys and situated in any sub-display zone that is separated from the main display area 11. Furthermore, because the processing unit 30 is electrically connected to the button module 20, the operating modes of the flexible electronic device 1a can be directly switched by operating the button module 20; i.e., switching between the e-reader mode and the audio communication mode.

As shown in FIG. 8, while the flexible electronic device 1a is in the folded state, a bottom surface 121 of the substrate 12, the surface which does not contact the flexible display module 1, is equipped with a sensing device 31. The sensing device 31 is electrically connected to the processing unit 30 and is capable of detecting whether the flexible electronic device 1a is in the opened state or in the folded state. In this embodiment, the sensing device 31 is an electromagnetic sensing device for detecting a distance between the A side and the B side of the flexible electronic device 1a. If the distance between the A side and the B side exceeds a certain pre-defined value, the operating mode of the flexible electronic device 1a is switched correspondingly by the processing unit 30, which is electrically connected to the sensing device 31; i.e., switching from the e-reader mode to the audio communication mode or vice versa. The sensing device 31 can increase the convenience of the flexible electronic device 1a because the operating modes can be switched spontaneously without manipulating the button module 20 by using the sensing device 31 and the processing unit 30. While the flexible display module 10 is in the opened state, the flexible electronic device 1a is in the e-reader mode; while the flexible display module 10 is in the folded state, the processing unit 30 switches the e-reader mode to the audio communication mode. In one embodiment of the present disclosure, the sensing device 31 can be an infrared sensing device, a distance sensor, a light blocking device, or the like.

As shown in FIG. 9a, with the detecting feature of the sensing device 31 and the switching feature of the processing unit 30, the flexible electronic device 1a enters the audio communication mode when the flexible electronic device 1a is in the folded state. Meanwhile, the sub-display zone 111, which is divided from the main display 11 of the flexible display module 10 and is located on the front side of the flexible electronic device 1, is used for displaying an operating interface of the audio communication mode in which numbers, graphics, and information or functions needed in the audio communication mode, such as a talk button and an end button, are displayed. As a result, the flexible electronic device 1a can be used as a mobile communication device, and the button module 20, which is mounted on the corresponding location of the sub-display zone 111, matches the figures or graphics displayed on the sub-display zone 111 for implementing operations of the mobile communication device. Furthermore, in one embodiment of the present disclosure, the sensing device 31 of the flexible electronic device 1a can also comprise a G-sensor such that information displayed on the flexible display module 10 can be rotated together with the rotation of the flexible electronic device 1a. Therefore, the audio communication mode of the flexible electronic device 1a can be operated in any direction to increase the applicability of the present disclosure. As shown in FIG. 9b, when the flexible electronic device 1 is folded, the sub-display zone 112 is located in the rear side of the flexible electronic device 1, which is the opposite side of the sub-display zones 111 for operating the interface of the audio communication mode. The sub-display zone 112 can display information or graphics chosen by users for enhancing the functionality and entertainment factors of the present disclosure.

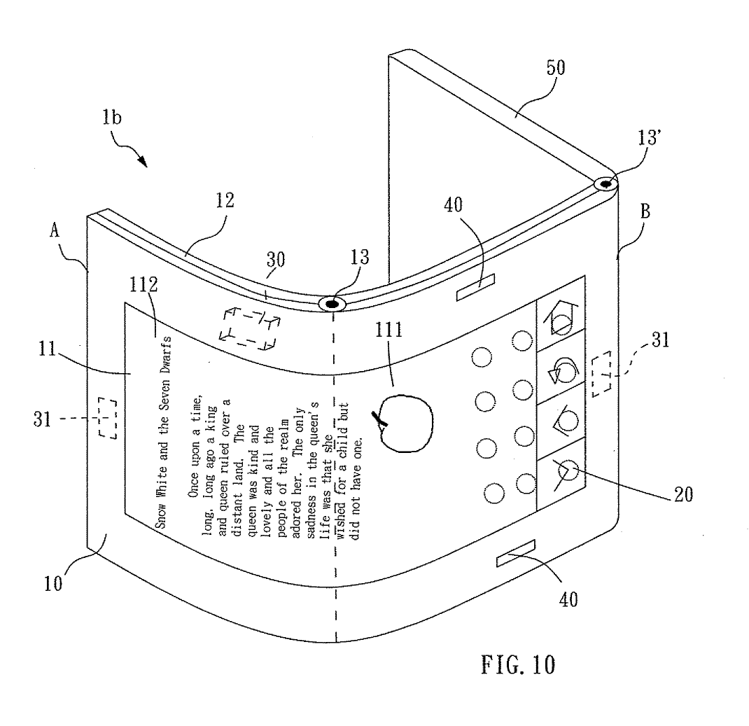

Please refer FIG. 10 regarding the third embodiment of the flexible electronic device of the present disclosure, wherein FIG. 10 is a schematic drawing showing the movement of folding the flexible electronic device. The most noticeable difference between the third embodiment of the flexible electronic device 1b and the second embodiment of the flexible electronic device 1a is: a cover 50 and a folding device 13′, both of which are disposed on the B side of the flexible electronic device 1b. The cover 50 is demountably and rotatably connected to the substrate 12 through the folding device 13′. As shown in FIG. 10, in this embodiment, the cover 50 is a transparent cover that is located on the rear side of the substrate 12 while the flexible electronic device 1 is in the opened state; while the flexible electronic device 1a is in the folded state, the cover 50 covers the sub-display zones 112 for protecting the sub-display zones 112. Moreover, because the cover 50 is a transparent cover, characters or graphics displayed on the sub-display zones 112 still remain visible.

To sum up, the flexible electronic devices 1a and 1b of the present disclosure combine the e-reader feature and the audio communication device. Due to the flexibility of the flexible display module 10, the flexible electronic devices 1a and 1b can implement different operating modes when in the folded or opened states. Furthermore, when the flexible electronic devices 1a and 1b are in the audio communication mode, the front sides and rear sides of the flexible electronic devices 1a and 1b are equipped with display screens. The front sides of the flexible electronic devices 1a and 1b are used for audio communication, the rear sides are used for displaying characterized graphics or information, and this two-sided operation is different from normal electronic devices, which have a single front-side display screen. The flexible electronic devices 1a and 1b can be folded outwards, and that direction of folding is different from that of conventional electronic devices. When the flexible electronic devices 1a and 1b are in the folded state, the display screens still remain on the exposed surfaces of the flexible electronic devices 1a and 1b, and the rear sides have transparent covers 50 to protect the displays from being scratched, which is a fairly sensible design.

Moreover, the above-mentioned embodiments are only for purposes of illustration. It is intended that the present disclosure cover modifications and variations of this disclosure provided they fall within the scope of the following claims and their equivalents. Therefore, it will be apparent to those skilled in the art that various modifications and variations can be made to the structure of the present disclosure without departing from the scope or spirit of the disclosure.

What is claimed is:

1. A flexible electronic device which can be operated in a plurality of operating modes comprising:
a substrate;
a flexible display module capable of being opened or folded mounted on the substrate; when the flexible display module is in the opened state, the flexible display module displays a main display area for displaying graphics; when the flexible display module is in the folded state, the main display area is divided into a plurality of sub-display zones, at least one of which is adapted for displaying graphics;
at least one folding device for folding the flexible display module;
a button module electrically connected to the flexible display module and mounted in one of the plurality of sub-display zones; and
a processing unit electrically connected to the button module for implementing operations of the flexible electronic device.

2. The flexible electronic device as claimed in claim 1, wherein the flexible display module is an e-paper display.

3. The flexible electronic device as claimed in claim 2, wherein the at least one folding device is at least one hinge.

4. The flexible electronic device as claimed in claim 3, wherein the plurality of sub-display zones is two sub-display zones; when the flexible electronic device is in the folded state, the two sub-display zones are separately located on a front side and a rear side of the flexible electronic device, wherein the button module is mounted in the sub-display zone of the front side of the flexible electronic device, and the sub-display zone without the button module is located on the rear of the flexible electronic device for displaying information.

5. A flexible electronic device that can be operated in an e-reader mode or an audio communication mode comprising:
a substrate;
a flexible display module capable of being opened or folded mounted on the substrate; when the flexible display module is in the opened state, the flexible display module displays a main display area for implementing the e-reader mode; when the flexible display module is in the folded state, the main display area is divided into a plurality of sub-display zones, at least one of which is adapted for implementing the audio communicating mode;
at least one folding device for folding the flexible display module;
a button module electronically connected to the flexible display module and mounted in one of the plurality of sub-display zones for implementing operations in the e-reader mode or in the audio communication mode;
a processing unit electronically connected to the button module; if the flexible display module is in the opened state, the flexible electronic device is switched to the e-reader mode, and if the flexible display module is in the folded state, the flexible electronic device is switched to the audio communication mode; and
an audio device electronically connected to the processing unit.

6. The flexible electronic device as claimed in claim 5, wherein the plurality of sub-display zones are two sub-display zones; when the flexible electronic device is in the folded state, the two sub-display zones are separately located on a front side and a rear side of the flexible electronic device, wherein the button module is mounted on the front side of the flexible electronic device for operating the audio communication mode, and the sub-display without the button module is located on the rear side of the flexible electronic device for displaying information.

7. The flexible electronic device as claimed in claim 6, wherein the flexible electronic device further comprises a cover which is rotatably connected to the substrate; when the flexible electronic device is in the folded state, the sub-display module that has no button module is covered by the cover for protecting the sub-display.

8. The flexible electronic device as claimed in claim 5, wherein the flexible display module is an e-paper display.

9. The flexible electronic device as claimed in claim 8, wherein the plurality of sub-display zones are two sub-display zones; when the flexible electronic device is in the folded state, the two sub-display zones are separately located on a front side and a rear side of the flexible electronic device, wherein the button module is mounted on the front side of the flexible electronic device for operating the audio communication mode, and the sub-display without the button module is located on the rear side of the flexible electronic device for displaying information.

10. The flexible electronic device as claimed in claim 9, wherein the flexible electronic device further comprises a cover which is rotatably connected to the substrate; when the flexible electronic device is in the folded state, the sub-display module that has no button module is covered by the cover for protecting the sub-display.

11. The flexible electronic device as claimed in claim 8, wherein the at least one folding device is at least one hinge.

12. The flexible electronic device as claimed in claim 11, wherein the plurality of sub-display zones are two sub-display zones; when the flexible electronic device is in the folded state, the two sub-display zones are separately located on a front side and a rear side of the flexible electronic device, wherein the button module is mounted on the front side of the flexible electronic device for operating the audio communication mode, and the sub-display without the button module is located on the rear side of the flexible electronic device for displaying information.

13. The flexible electronic device as claimed in claim 11, wherein the button module comprises a plurality of physical keys or a plurality of virtual keys.

14. The flexible electronic device as claimed in claims 13, wherein the plurality of sub-display zones are two sub-display zones; when the flexible electronic device is in the folded state, the two sub-display zones are separately located on a front side and a rear side of the flexible electronic device, wherein the button module is mounted on the front side of the flexible electronic device for operating the audio communication mode, and the sub-display without the button module is located on the rear side of the flexible electronic device for displaying information.

15. The flexible electronic device as claimed in claim 13, wherein the flexible electronic device further comprises:
a sensing device mounted on the substrate for detecting whether the flexible electronic device is in the opened state or in the folded state.

16. The flexible electronic device as claimed in claim 15, wherein the plurality of sub-display zones are two sub-display zones; when the flexible electronic device is in the folded state, the two sub-display zones are separately located on a front side and a rear side of the flexible electronic device, wherein the button module is mounted on the front side of the flexible electronic device for operating the audio communication mode, and the sub-display without the button module is located on the rear side of the flexible electronic device for displaying information.

17. The flexible electronic device as claimed in claim 15; when the audio communication mode is implemented, the sub-display zones without the button module are used for displaying information.

18. The flexible electronic device as claimed in claim 17, wherein the plurality of sub-display zones are two sub-display zones; when the flexible electronic device is in the folded state, the two sub-display zones are separately located on a front side and a rear side of the flexible electronic device, wherein the button module is mounted on the front side of the flexible electronic device for operating the audio communication mode, and the sub-display without the button module is located on the rear side of the flexible electronic device for displaying information.

19. The flexible electronic device as claimed in claim 18, wherein the flexible electronic device further comprises a cover which is rotatably connected to the substrate; when the flexible electronic device is in the folded state, the sub-display module that has no button module is covered by the cover for protecting the sub-display.

20. The flexible electronic device as claimed in claim 19, wherein the cover is a transparent cover demountably connected to the substrate.
